(19) United States
(12) Patent Application Publication
(10) Pub. No.: US 2024/0317935 A1
(43) Pub. Date: Sep. 26, 2024

(54) ORGANYLOXYSILYL-TERMINATED POLYMERS ON THE BASIS OF 1,3-DIOXOLANE COPOLYMER BUILDING BLOCKS

(71) Applicant: WACKER CHEMIE AG, Munich (DE)

(72) Inventors: Volker Stanjek, Ampfing (DE); Theresa Dellermann, München (DE); Lars Zander, Altötting (DE)

(73) Assignee: Wacker Chemie AG, Munich (DE)

(21) Appl. No.: 18/571,813

(22) PCT Filed: Jun. 27, 2022
(86) PCT No.: PCT/EP2022/067565

§ 371 Date: Dec. 19, 2023

(30) Foreign Application Priority Data
Jun. 29, 2021 (DE) 10 2021 206 774.3

(51) Int. Cl. C08G 65/336; C08G 65/16; C08K 3/26; C08K 9/04; C09J 171/00

(52) U.S. Cl. CPC C08G 65/336; C08G 65/16; C08K 3/26; C08K 9/04; C09J 171/00; C08K 2003/265

(57) ABSTRACT

The Applicants respectfully request that the abstract of the instant application be removed in its entirety and replaced with the following wording.
Organyloxysilyl-terminated polymers end groups of the formula (I) and 1,3-dioxolane copolymer units (DP) of the general formula (II) in the backbone. Along with methods of producing and uses for the same.

The invention relates to crosslinkable silane-terminated polymers comprising 1,3-dioxolane copolymer units in the backbone thereof, to a process for the preparation thereof and to compositions comprising the polymers (P). The polymers have high hydrophilicity and particularly good curing resulting therefrom.

Moisture-crosslinkable preparations are generally known. They are widely used as adhesives and sealants and also for coatings. An important moisture-reactive binder for such products are silyl-functionalized polymers. Preferred among these, in turn, are linear or single-branched polypropylene glycols and/or polyurethanes based on these polypropylene glycols, which have terminal alkoxysilyl groups at the ends of the respective polymer chains. Thus, this product group combines several advantages:
The polymers having a backbone based on polypropylene glycols are still liquid prior to cross-linking thereof, even with the very long chain lengths required for this application.
The alcohols released as cleavage products during cross-linking are non-corrosive and toxicologically harmless at the low concentrations released.
The cured polymer formulations are characterized by very good mechanical properties.

Corresponding alkoxysilane-terminated polymers have long been known in the prior art and are commercially available, for example, under the trade names GENIOSIL® STP-E (Wacker Chemie AG), MS-Polymer (Kaneka), DESMOSEAL® (Bayer AG) or SPUR® (Momentive).

However, a disadvantage of many systems according to the prior art is low reactivity of the corresponding polymers towards moisture, which makes aggressive catalysis necessary. The corresponding mixtures therefore typically comprise considerable amounts of toxicologically harmful tin catalysts.

Here, the use of so-called α-silane-terminated prepolymers is advantageous, which have alkoxysilyl groups linked to an adjacent urethane unit by a methylene spacer. This compound class is highly reactive and requires neither tin catalysts nor strong acids or bases to achieve high curing rates in contact with air. Corresponding products are also commercially available here under the trade name GENIOSIL® STP-E from Wacker-Chemie AG.

However, even these systems, which cure particularly rapidly on contact with atmospheric moisture, still have the problem when non-porous substrates such as glass, metals or plastics are bonded over large areas. For instance, the curing rate of a deep adhesive joint is limited not only by the reactivity of the cross-linkable polymers, but also by the limited availability of water traces inside the joint that are necessary for curing. And the latter, when bonding or even sealing non-porous substrates, depends primarily on the rate at which water molecules can diffuse from the surface of the adhesive or sealing joint through the adhesive matrix into the deeper joint layers.

In principle, this problem can be solved by using so-called 2-component systems, in which the first component comprises the moisture-curing polymer and the second component contains water. If both components are then mixed together directly before application, diffusion of water from atmospheric moisture into the interior of the joint is no longer necessary and the adhesive or sealant cures uniformly even in deeper layers. However, such 2-component systems are extremely user-unfriendly and difficult to apply even for professional users. Therefore, they are thus only used if no one-component alternative exists for the respective application.

Therefore, to enable improved curing of even deep adhesive or sealant joints without using a 2-component system, an adhesive matrix that allows more rapid water diffusion would be highly desirable.

A further disadvantage of all commercially available silane-crosslinking polymers existing to date is their polypropylene glycol-based backbone. For instance, polypropylene glycols have so far been produced from raw materials that are exclusively obtained from fossil carbon sources. The option would therefore be desirable to be able to also use other, ecologically more favorable polymer units as a basis for the production of silane-crosslinkable polymers.

One way to achieve this aim is to utilize CO₂ to produce these polymer units, and thus to integrate CO₂ into the value chain, not as waste, but as starting material.

In this context, polyacetals could be distinctively attractive polymer units for the development of novel silane-crosslinking polymers. For instance, these can be produced via the intermediate stage of cyclic acetals, inter alia, by catalytic fixation of CO₂ with green hydrogen.

However, it is problematic that classic polyacetals, also called polyoxymethylenes (POM), such as can be obtained for example by polymerization of formaldehyde, trioxane (POM-H) or by ring-opening polymerization of 1,3-dioxolane (POM-C), are solid at room temperature. And therefore they are not suitable for production of binders for liquid or pasty adhesives, sealants or coatings that are applied solvent-free at room temperature and are intended to be cured only during or after the application thereof.

The object of the invention was therefore to develop silane-terminated polymers based on polymer units that can be produced wholly or partially from non-fossil carbon sources and which should also enable better diffusion of water molecules through the polymer matrix.

The invention relates to organyloxysilyl-terminated polymers (P) having end groups of the formula (I)

—(CR¹₂)_{b}—SiRₐ(OR²)₃₋ₐ (I),
where
R may be identical or different and is a monovalent, unsubstituted or substituted, SiC-bonded hydrocarbon radical,
R¹ may be identical or different and is a hydrogen atom or a monovalent, unsubstituted or substituted hydrocarbon radical,
R² may be identical or different and is a hydrogen atom or a monovalent, unsubstituted or substituted hydrocarbon radical,
a may be identical or different and is 0, 1 or 2, preferably 0 or 1, and
b may be identical or different and is an integer from 1 to 10, preferably 1, 3 or 4, particularly preferably 1 or 3,
which comprise 1,3-dioxolane copolymer units (DP) of the general formula (II) in the backbone thereof

—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴O—CH₂)]_{y2}—O— (II),
where
R³ may be identical or different and is hydrogen or a monovalent, unsubstituted or substituted C₁- to C₁₈-alkyl radical,
R⁴ may be identical or different and is hydrogen or a monovalent, unsubstituted or substituted C₁- to C₁₈-alkyl radical,
x1+x2 has values of 10 to 2000,
y1+y2 has values of 3+(x1+x2+y1+y2)/100 to 90+(x1+x2+y1+y2)/100,
with the proviso that, in the [O—CH₂—O—CHR³—CHR⁴-]_{y1} and [O—CHR³—CHR⁴O—CH₂-]_{y2} units, in each case at least one radical R³ or R⁴ is a C₁- to C₁₈-alkyl radical.

The 1,3-dioxolane copolymer units (DP) of the formula (II) comprise the units [O—CH₂—O—CH₂—CH₂-]ₓ₁, [O—CH₂—CH₂O—CH₂-]ₓ₂, [O—CH₂—O—CHR³—CHR⁴-]_{y1}, [O—CHR³—CHR⁴O—CH₂-]_{y2}, randomly distributed or in blocks.

Examples of unsubstituted radicals R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical, isooctyl radicals and the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical and methylcyclohexyl radicals; alkenyl radicals such as the vinyl, 1-propenyl and the 2-propenyl radical; aryl radicals such as the phenyl, naphthyl, anthryl and phenanthryl radical; alkaryl radicals such as o-, m-, p-tolyl radicals; xylyl radicals and ethylphenyl radicals; and aralkyl radicals such as the benzyl radical, the α- and β-phenylethyl radical.

Examples of substituted radicals R are haloalkyl radicals and haloaryl radicals such as the o-, m- and p-chlorophenyl radical.

Preferably, radical R is an unsubstituted or halogen-substituted monovalent hydrocarbon radicals having 1 to 6 carbon atoms, particularly preferably alkyl radicals having 1 or 2 carbon atoms, especially the methyl radical.

Examples of radicals R¹ are hydrogen atom, the radicals specified for R and unsubstituted or substituted hydrocarbon radicals bonded to the carbon atom via nitrogen, phosphorus, oxygen, sulfur, carbon or a carbonyl group.

The radical R¹ is preferably a hydrogen atom and unsubstituted or substituted hydrocarbon radicals having 1 to 20 carbon atoms, especially a hydrogen atom.

Examples of radical R² are a hydrogen atom or the examples specified for the R radical.

The radical R² is preferably a hydrogen atom or unsubstituted or halogen-substituted alkyl radicals having 1 to 10 carbon atoms, particularly preferably unsubstituted or halogen-substituted alkyl radicals having 1 to 4 carbon atoms, especially the methyl and ethyl radical.

Examples of alkyl radicals R³ and R⁴ are hydrogen atoms, linear and branched alkyl radicals, such as the methyl, ethyl, isooctyl, n-octyl radical, and cycloalkyl radicals such as the cyclohexyl radical. Preferably R³ and R⁴ are hydrogen atoms or C₁- to C₆-alkyl radicals, particularly preferably hydrogen atoms, methyl, ethyl, n-propyl or isopropyl radicals.

In each case preferably only one radical R³ or R⁴ in the [O—CH₂—O—CHR³—CHR⁴-]_{y1} and [O—CHR³—CHR⁴O—CH₂-]_{y2} units is a C₁- to C₁₈-alkyl radical, whereas the other radical is in each case a hydrogen atom.

Preferably x1+x2 has values of 20 to 1000, particularly preferably of 30 to 500, in particular of 50 to 300.

Preferably y1+y2 has values of 5·(x1+x2+y1+y2)/100 to 50·(x1+x2+y1+y2)/100, particularly preferably values of 10·(x1+x2+y1+y2)/100 to 30·(x1+x2+y1+y2)/100, in particular values of 14+(x1+x2+y1+y2)/100 to 25+(x1+x2+y1+y2)/100.

The 1,3-dioxolane copolymer units (DP) of the formula (II) preferably have a number-average molecular weight Mₙ between 750 and 300 000 daltons, particularly preferably between 1500 and 125 000 daltons, especially preferably between 4000 and 24 000 daltons, in particular between 6000-20 000 daltons.

The organyloxysilyl-terminated polymers (P) may be branched, preferably having 1 to 3 branching sites and correspondingly 3 to 5 chain ends. Only some or even all of the chain ends may be terminated with silane groups of the formula (I) here. Preferably, at least 90%, particularly preferably at least 95% of all chain ends are terminated with silane groups of the formula (I).

In a preferred embodiment, the polymers (P) are however unbranched and thus have two chain ends. One or even both chain ends may be terminated with silane groups of the formula (I). Preferably, however, at least 90%, particularly preferably at least 95% of all chain ends are terminated with silane groups of the formula (I).

The organyloxysilyl-terminated polymers (P) are preferably produced by reacting 1,3-dioxolane copolymers terminated with hydroxyl groups (DP-OH) of the general formula (III)

H—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴O—CH₂)]_{y2}—OH (III),

where all variables have the definition specified for formula (II) and thus all requirements specified for this formula are met.

The hydroxyl-terminated 1,3-dioxolane copolymers (DP-OH) preferably have here a number-average molecular weight Mₙ between 750 and 300 000 daltons, particularly preferably between 1500 and 125 000 daltons, especially preferably between 4000 and 24 000 daltons, in particular between 6000-20 000 daltons. Compared to the polymer units (DP) of the formula (II) resulting from the use of the 1,3-dioxolane copolymers (DP-OH), the average molar mass is obviously increased by the weight of the two terminal hydrogen atoms.

In the context of the present invention, the number-average molar mass Mₙ is preferably determined here by Size Exclusion Chromatography (SEC) against a polystyrene standard, in THE, at 60° C., flow rate 1.2 ml/min, and detection by R¹ (refractive index detector) on a Styragel HR3-HR4-HR5-HR5 column set from Waters Corp. USA with an injection volume of 100 μl.

The hydroxyl-terminated 1,3-dioxolane copolymers (DP-OH) preferably have a dynamic viscosity at 25° C. of between 50 mPas-500 Pas, particularly preferably between 500 mPas-200 Pas, in particular between 1 Pas-100 Pas.

In the context of the present invention, the viscosity of non-pasty liquids is determined in accordance with ISO 2555 preferably after heating to 23° C. using a DV 3 P rotational viscometer from A. Paar (Brookfield systems) using spindle 6 at 5 Hz.

Numerous processes are known which are suitable for producing organyloxysilyl-terminated polymers from hydroxyl-functional prepolymers, for example polypropylene glycols. All these processes can be easily transposed to converting the hydroxyl-terminated 1,3-dioxolane copolymers (DP-OH) to the polymers (P) according to the invention. All process parameters such as temperature, reaction time, catalysis etc. can remain unchanged here. The only difference is that a hydroxyl-terminated 1,3-dioxolane copolymer (DP-OH) is used as reactant, i.e. as hydroxyl-functional polymer.

In a common process (P1), the hydroxyl group-containing polymers (DP-OH) are first reacted with a compound having a group reactive to hydroxyl groups and a double bond, preferably allyl chloride, to give a corresponding vinyl-terminated polymer, which is then hydrosilylated with a silane of formula (IV)

H—SiRₐ(OR²)₃₋ₐ (IV),

where all variables have the definitions specified for formula (I). Suitable processes for carrying out this reaction are known and are described, inter alia, in EP 1 566412 A1 (paragraphs [0144]ff, method (a)). Also, the instructions for carrying out silylation of the hydroxyl-terminated polypropylene glycols used in the preparation examples specifically described in EP 1 566412 A1 can be directly applied to the silylation of the hydroxyl-terminated 1,3-dioxolane copolymers (DP-OH).

In a second, likewise common process (P2), the hydroxyl group-containing polymers (DP-OH) are reacted with at least one isocyanate-functional compound. These are preferably di- or polyisocyanates. Examples of customary diisocyanates are diisocyanatodiphenylmethane (MDI), both in the form of crude or technical grade MDI and in the form of pure 4,4′ or 2,4′ isomers or mixtures thereof, toluene diisocyanate (TDI) in the form of various regioisomers thereof, diisocyanatonaphthalene (NDI), isophorone diisocyanate (IPDI) or also hexamethylene diisocyanate (HDI). Examples of polyisocyanates are polymeric MDI (P-MDI), triphenylmethane triisocyanate or else trimerizates (biurets or isocyanurates) of the aforementioned diisocyanates.

The isocyanates may be used here in stoichiometric deficiency (variant (V2-1)) or in excess (variant (V2-2)) with respect to the ratio of the isocyanate groups to the hydroxyl groups of the hydroxyl group-containing polymer (DP-OH). In variant (V2-1), a polyurethane polymer is obtained, the chain ends of which are terminated with hydroxyl groups, and in variant (V2-1), a polymer the chain ends of which consist of isocyanate groups.

The hydroxyl group-functional polyurethane polymer obtained in variant (V2-1) is preferably reacted with an isocyanate-functional silane of the formula (V)

OCN—(CR¹₂)_{b}—SiRₐ(OR²)₃₋ₐ (V),

where the radicals and indices have one of the definitions specified in formula (I). Suitable processes for carrying out this reaction are known and are described, inter alia, in EP 0 931 800 A (paragraphs [0011]-[0022] and examples 1-5).

The isocyanate-functional polymer obtained in variant (V2-2), on the other hand, is preferably reacted with an isocyanate-reactive silane of the formula (VI)

Z—(CR¹₂)_{b}—SiRₐ(OR²)₃₋ₐ (VI),
where
Z is an isocyanate-reactive group and all other radicals and indices have a definition specified for formula (I).

The isocyanate-reactive group Z is preferably an hydroxyl group or an amino group, particularly preferably an amino group of the formula NHR′, where R′ has one of the definitions specified for the R radicals or is a —CH(COOR″)—CH₂—COOR″ group, in which R″ may be identical or different and has a definition specified for R.

Examples of radicals R′ are cyclohexyl, cyclopentyl, n- and isopropyl, n-, iso- and t-butyl, the various stereoisomers of the pentyl radical, hexyl radical or heptyl radical and also the phenyl radical.

The radical R′ is preferably a-CH (COOR″)—CH₂—COOR″ group or an optionally substituted hydrocarbon radical having 1 to 20 carbon atoms, particularly preferably a linear, branched or cyclic alkyl group having 1 to 20 carbon atoms or an optionally halogen-substituted aryl group having 6 to 20 carbon atoms.

The radicals R″ are preferably alkyl groups having 1 to 10 carbon atoms, particularly preferably methyl, ethyl or propyl radicals.

Suitable processes for carrying out process variant (V2-2) are known and described, inter alia, in EP 1 093 482 B1 (paragraphs [0014]-[0023], [0039]-[0055] and also example 1 and comparative example 1) or EP 1 641 854 B1 (paragraphs-[0035], examples 4 and 6 and also comparative examples 1 and 2).

In a particularly preferred process (P3), the polymers (P) according to the invention are obtained by a direct reaction of the hydroxyl-terminated 1,3-dioxolane copolymers (DP-OH) with isocyanate-functional silanes of the formula (V). Suitable processes for carrying out this reaction are known and described, inter alia, in EP 1 535 940 B1 (paragraphs [0005]-[0025] and examples 1-3 and comparative example 1-4) or EP 1 896 523 B1 (paragraphs [0008]-[0047]), which are to be included in the disclosure content of the present application.

The polymers of the formula (VII) obtainable by the preferred process (P3)

(RO⁵)₃₋ₐR⁴ₐSi—(CR³₂)_{b}—NH—CO—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴O—CH₂—)_{y2}]—O—CO—NH—(CR³₂)_{b}—SiR⁴ₐ(OR⁵)₃₋ₐ (VII),

where all variables have the definitions specified in formula (I) and (II) and thus all requirements specified for these formulae are met, are a particularly preferred embodiment of the invention.

The 1,3-dioxolane copolymers terminated with hydroxyl groups (DP-OH) of the general formula (III) above can be produced in a simple manner and with short reaction times.

The production is preferably carried out here by copolymerization of 1,3-dioxolane with one or more alkyl-substituted 1,3-dioxolanes of the general formula (VII)

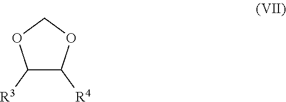

in the presence of a Lewis or Brønsted acid, where the alkyl radicals R³ and R⁴ have the definitions specified for formula (II).

The process is a ring-opening polymerization of the dioxolane monomers by way of cationically induced catalysis. The catalyst is a Lewis or Brønsted acid.

In the process, preferably at least 10 mol %, particularly preferably at least 20 mol %, in particular at least 30 mol % of alkyl-substituted 1,3-dioxolane of the general formula II, based on the total amount of 1,3-dioxolane and alkyl-substituted 1,3-dioxolane of the general formula II, is used.

The amount of alkyl-substituted 1,3-dioxolanes used is decisive here for the ratio (y1+y2)/(x1+x2+y1+y2) in the hydroxyl-terminated 1,3-dioxolane copolymer (DP-OH) obtained during copolymerization. It should be noted here, however, that the process usually requires the use of somewhat more alkyl-substituted 1,3-dioxolane of the general formula (VII) than would be necessary from a purely arithmetical point of view, since this is less reactive than the unsubstituted 1,3-dioxolane and is accordingly incorporated into the polymer chain somewhat less frequently.

Examples of acids are Lewis acids, such as BF₃, AlCl₃, TiCl₃, SnCl₄, SO₃, PCl₅, POCl₃, FeCl₃ and hydrates thereof and ZnCl₂; Brønsted acids, such as boric acid, tetrafluoroboric acid, nitric acid, nitrous acid, phosphoric acid, phosphorous acid, hypophosphorous acid, sulfuric acid, sulfurous acid, peroxysulfuric acid, hydrochloric acid, hydrofluoric acid, hydroiodic acid, hydrobromic acid, perchloric acid, hexafluorophosphoric acid, aluminum chloride, zinc chloride, benzenesulfonic acid, p-toluenesulfonic acid, methanesulfonic acid, trifluoromethanesulfonic acid and carboxylic acids, such as chloroacetic, trichloroacetic, acetic, acrylic, benzoic, trifluoroacetic, citric, crotonic, formic, fumaric, maleic, malonic, gallic, itaconic, lactic, tartaric, oxalic, phthalic and succinic acids, acidic ion exchangers, acidic zeolites, acid-activated bleaching earth and acid-activated carbon black.

Particular preference is given to boron trifluoride etherate and trifluoromethanesulfonic acid.

Initiators may be used in the process. A difunctional alcohol is preferably used as initiator, particularly preferably ethylene glycol.

The process may be performed in the presence or in the absence of aprotic solvents. If aprotic solvents are used, preference is given to solvents or solvent mixtures with a boiling point or boiling range of up to 120° C. at 0.1 MPa. Examples of such solvents are ethers, such as dioxane, tetrahydrofuran, diethyl ether, methyl tert-butyl ether, diisopropyl ether, diethylene glycol dimethyl ether; chlorinated hydrocarbons, such as dichloromethane, trichloromethane, tetrachloromethane, 1,2-dichloroethane, trichloroethylene; hydrocarbons, such as pentane, n-hexane, hexane isomer mixtures, heptane, octane, benzine, petroleum ether, benzene, toluene, xylenes; siloxanes, particularly linear dimethylpolysiloxanes with trimethylsilyl end groups having preferably 0 to 6 dimethylsiloxane units, or cyclic dimethylpolysiloxanes having preferably 4 to 7 dimethylsiloxane units, for example hexamethyldisiloxane, octamethyltrisiloxane, octamethylcyclotetrasiloxane and decamethylcyclopentasiloxane;
ketones, such as acetone, methyl ethyl ketone, diisopropyl ketone, methyl isobutyl ketone (MIBK); esters, such as ethyl acetate, butyl acetate, propyl propionate, ethyl butyrate, ethyl isobutyrate; carbon disulfide and nitrobenzene, or mixtures of these solvents.

The term “solvent” does not mean that all reaction components must dissolve therein. The reaction may also be performed in a suspension or emulsion of one or more reactants. The reaction may also be performed in a solvent mixture with a miscibility gap, at least one reactant in each case being soluble in each of the mixed phases.

Particularly preferably, a solution of trifluoromethanesulfonic acid and an initiator is used, with methylene chloride being used as preferred solvent.

The amount of catalyst and initiator used determines the achievable molecular weight of the 1,3-dioxolane copolymer (DP-OH) of the general formula (IV).

The process is preferably performed at a temperature of between 10° C. and 60° C., particularly preferably between 15° C. and 40° C., in particular between 21° C. and 30° C. A reaction temperature of 23° C. is very particularly preferred.

The reaction is preferably worked up by inactivating the catalyst by means of a suitable base, washing with a hydrocarbon, such as heptane, and subsequent removal thereof by distillation under reduced pressure. Suitable bases are preferably pyridine, triethylamine or aqueous sodium hydroxide solution.

The invention is based on several surprising findings:
firstly, the hydroxyl-terminated 1,3-dioxolane copolymers (DP-OH) composed of 1,3-dioxolane and 1,3-dioxolane substituted at the 4-position and/or 5-position are liquid over a wide temperature range including room temperature. This also applies when they have average molar masses of >>10 000 daltons. And in view of this surprising property, they are eminently suitable as polymer units (DP) for constructing the polymers (P) according to the invention by one of the processes P1 to P3 of the invention and are therefore very well suited for further processing.

The polymers (P) based on 1,3-dioxolane copolymer units (DP) are highly polar and thus hydrophilic. Thus, they are an ideal binder for adhesives and sealants, allowing a rapid diffusion of water molecules into the deeper layers of an adhesive or sealing joint and thus a particularly good, rapid and uniform curing of the corresponding adhesive and sealant.

The polymers (P) are a suitable binder for adhesives and sealants which, after curing thereof, exhibit excellent properties that are broadly comparable to those of a conventional silane-terminated polypropylene glycol-based polymer. This completely novel product group, the raw material basis of which is obtainable via the intermediate stage of cyclic acetals by catalytic fixation of CO₂ with green hydrogen, is therefore an alternative with which existing products, which are obtainable exclusively from fossil carbon sources, can be completely or at least partially replaced.

The organyloxysilyl-terminated polymers (P) produced according to the invention can be used wherever organyloxysilyl-terminated polymers have also been used up to now. They are especially suitable as a constituent of cross-linkable compositions, i.e. as binders for adhesives, sealants and/or coatings. Due to their improved through-curing, they are particularly suitable for use in deep adhesive or sealing joints and also for large-area adhesion of non-porous substrates.

Therefore, the invention also relates to compositions comprising the organyloxysilyl-terminated polymers (P) and, depending on the specific application or the respective requirement profile, at least one further constituent selected from (A) nitrogen-containing organosilicon compounds, (B) silicone resins, (C) catalysts, (D) adhesion promoters, (E) water scavengers, (F) fillers, (G) additives and (H) aggregates.

The compositions according to the invention are preferably crosslinkable compositions comprising
(P) organyloxysilyl-terminated polymers (P),
optionally (A) nitrogen-containing organosilicon compounds,
optionally (B) silicone resins,
optionally (C) catalysts,
optionally (D) adhesion promoters,
optionally (E) water scavengers,
optionally (F) fillers,
optionally (G) additives and
optionally (H) aggregates.

The components (A) to (H) and the preferred amounts of use thereof are described many times here, for example WO-A 2015024773 on page 12, line 24 to page 23, line 21, which is to be included in the disclosure content of the present application.

The compositions according to the invention are particularly preferably crosslinkable compositions comprising
(P) organyloxysilyl-terminated polymers,
(A) nitrogen-containing organosilicon compounds,
optionally (B) silicone resins,
optionally (C) catalysts,
optionally (D) adhesion promoters,
optionally (E) water scavengers,
optionally (F) fillers,
optionally (G) additives and
optionally (H) aggregates.

The compositions according to the invention are especially preferably crosslinkable compositions consisting of
(P) organyloxysilyl-terminated polymers,
(D) nitrogen-containing organosilicon compounds,
optionally (B) silicone resins,
optionally (C) catalysts,
optionally (D) adhesion promoters,
optionally (E) water scavengers,
optionally (F) fillers,
optionally (G) additives and
optionally (H) aggregates.

The components used according to the invention may each be one type of such a component or else a mixture of at least two types of a respective component.

The adhesives, sealants or coatings according to the invention may be produced in any manner known per se, such as by methods and mixing processes common for the preparation of moisture-curing compositions. The sequence in which the various constituents are mixed with one another can be varied as desired here.

This mixing may be carried out at room temperature and the pressure of the ambient atmosphere, i.e. about 900 to 1100 hPa. If desired, this mixing may however also be carried out at higher temperatures, for example at temperatures in the range of 30 to 130° C. Furthermore, it is possible to mix temporarily or constantly under reduced pressure, for example at 30 to 500 hPa absolute pressure, in order to remove volatile compounds and/or air. The mixing according to the invention is preferably carried out under exclusion of moisture.

The polymers (P) according to the invention have the advantage that they can be produced just as quickly and easily as conventional silane-crosslinking polymers based on polypropylene glycols.

The polymers (P) according to the invention have the advantage that they are highly fluid and have comparatively low viscosity such that they can be excellently compounded to give finished adhesives and sealants.

The polymers (P) according to the invention have the advantage that, although they represent a completely novel product group, they may be further processed to adhesives and sealants in the same way as conventional silane-crosslinking polymers based on polypropylene glycols. Neither new or modified plants nor new or modified working techniques are necessary for further processing.

The polymers (P) according to the invention have the advantage that they can be used to produce adhesives and sealants having excellent mechanical properties.

The polymers (P) according to the invention have the advantage that they can be used to produce adhesives and sealants that cure particularly rapidly and evenly.

The polymers (P) according to the invention have the advantage that the adhesives and sealants that can be produced therefrom have an excellent adhesion profile to countless substrates such as plastics including PVC, metals, concrete, wood, mineral substrates, glass, ceramics and painted surfaces and are therefore suitable for bonding and/or sealing all these materials.

The polymers (P) according to the invention have the advantage that they are transparent, colorless and color-stable, and are therefore suitable also for producing transparent and crystal clear adhesives and sealants.

The polymers (P) according to the invention have the advantage that they can be produced by fixing CO₂, whereby they are particularly climate friendly.

The compositions that can be produced from the polymers (P) according to the invention may be used for all intended purposes, for which compositions which can be stored under exclusion of water and which cross-link to form elastomers when exposed to water at room temperature can be used.

The compositions that can be produced from the polymers (P) according to the invention are thus excellently suitable, for example, for sealing and flexible bonding of metallic components. They can thus be used as mounting adhesives, for automotive construction and for bus, truck and rail vehicle production. Furthermore, they are suitable for window construction, especially of skylights, structural glass bonding or for the production of photovoltaic elements, display cases, and for example for the production of protective coatings or moldings and for the insulation of electrical or electronic devices.

In the examples described below, all viscosity data are based on a temperature of 25° C. Unless stated otherwise, the examples that follow are carried out at a pressure of the surrounding atmosphere, that is to say at around 1000 hPa, and at room temperature, that is to say at around 23° C., or at a temperature that results when combining the reactants at room temperature without supplemental heating or cooling, and at a relative humidity of about 50%. In addition, unless otherwise stated, all reported parts and percentages relate to weight.

### EXAMPLES

### Production Example 1: Production of a 1,3-Dioxolane Copolymer Terminated with Hydroxyl Groups (DP-OH)

Preparation of the catalyst solution: In a Schlenk flask with septum, 150 ml of dry dichloromethane, 15 ml of ethylene glycol and 1.14 ml of trifluoromethanesulfonic acid are mixed under a nitrogen atmosphere.

154 ml of the catalyst solution prepared above are transferred to a laboratory reactor equipped with KPG stirrer, thermometer, nitrogen connection and septum, and temperature-controlled at 23° C. To this solution are added 1.15 kg of 4-ethyl-1,3-dioxolane (10.9 mol) and 770 ml (10.9 mol) of 1,3-dioxolane and the mixture stirred at 23° C. The reaction mixture becomes more viscous during the reaction time and turns pink. After 5 hours, ca. 20 ml of pyridine and 100 ml of dichloromethane are added until the reaction solution decolorizes. The product mixture is washed firstly with heptane and then with water, until a pH of 7 is reached.

Finally, all volatile constituents are removed under vacuum (1 mbar) and a viscous oil is obtained.

### Production Example 2: Production of a Polymer (P) According to the Invention

In a 1 L three-necked flask equipped with dropping funnel, KPG stirrer and thermometer, 475 g of the 1,3-dioxolane copolymer from example 1 are initially charged, heated to 80° C. and dried for 2 h at a pressure of 10 mbar (vacuum).

The vacuum is released using nitrogen, and 18.5 g of a-isocyanatomethyl methyldimethoxysilane (GENIOSIL® XL 42, commercially available from Wacker Chemie AG, D-Munich) are added dropwise with stirring over 15 minutes. The temperature remains here at 80° C. Then 0.07 g of a bismuth-containing catalyst (commercially available under the name “Borchi-Kat 315” from OMG-Borchers, D-Langenfeld) is added. There is a slight warming of the reaction mixture (<5° C.). The mixture is then stirred at 80° C. for 2 hours. Afterwards, a small isocyanate peak is still present in the IR spectrum of the reaction mixture, corresponding to 2 to 5% of the amount of isocyanate groups originally used.

The mixture is allowed to cool to 50° C. and 1.3 g of methanol is added at this temperature to eradicate the remaining isocyanate. After 0.5 h, the reaction mixture is allowed to cool to room temperature. An IR spectrum recorded thereafter confirms the absence of isocyanate.

### Example 1: Adhesive-Sealant Formulation Based on a Polymer (P) According to the Invention

168.0 g of polymer from production example 2 are homogenized in a laboratory planetary mixer from PC-Laborsystem, equipped with two cross-arm mixers, at ca. 25° C., with 8.0 g of vinyltrimethoxysilane (commercially available as GENIOSIL® XL 10 from Wacker Chemie AG, D-Munich) for 2 minutes at 200 rpm.

Then, 220.0 g of ground calcium carbonate coated with stearic acid, having a mean particle diameter (D50%) of ca. 0.4 μm (commercially available under the name Omyabond 302 from Omya, D-Cologne) are added and macerated for one minute with stirring at 600 rpm. Finally, 4.0 g of N-[2-aminoethyl]-3-aminopropyltrimethoxysilane (commercially available as GENIOSIL® GF 91 from Wacker Chemie AG, D-Munich) is mixed in for 1 minute at 200 rpm and homogenized for 1 minute at 200 rpm under partial vacuum (ca. 100 mbar) and stirred until bubble-free.

The composition thus obtained is filled into two 310 ml PE cartridges (ca. 200 g per cartridge) and stored for 24 hours at 20° C. before investigation.

### Comparative Example C1

The Procedure is the Same as in Example 1, but Instead of the polymer of production example 2 according to the invention, the identical amount of a polypropylene glycol silane-terminated at both ends having a mean molar mass (Mₙ) of 12 000 g/mol and end groups of the formula-O—C(═O)—NH—CH₂—SiCH₃ (OCH₃)₂ (commercially available under the name GENIOSIL® STP-E10 from Wacker Chemie AG, D-Munich) is used.

### Example 2: Adhesive-Sealant Formulation Based on a Polymer (P) According to the Invention

116.0 g of polymer from production example 2 are homogenized in a laboratory planetary mixer from PC-Laborsystem, equipped with two cross-arm mixers, at ca. 25° C., with 80 g of a polyethylene glycol butyl-terminated at both ends having a number-average molar mass (Mₙ) of 300 g/mol (commercially available under the name Polyglycol BB 300 from Clariant, D-Gendorf) and 8.0 g of vinyltrimethoxysilane at 200 rpm for 2 minutes.

Then, 192.0 g of Omyabond 302 are added and macerated with stirring at 600 rpm for one minute. Finally, 4.0 g of 3-aminopropyltrimethoxysilane (commercially available as GENIOSIL® GF 96 from Wacker Chemie AG, D-Munich) is mixed in for 1 minute at 200 rpm and homogenized for 1 minute at 200 rpm under partial vacuum (ca. 100 mbar) and stirred until bubble-free.

The composition thus obtained is filled into two 310 ml PE cartridges (ca. 200 g per cartridge) and stored for 24 hours at 20° C. before investigation.

### Comparative Example C2

The procedure is the same as in example 3, but instead of the polymer from production example 2 according to the invention, the identical amount of GENIOSIL® STP-E10 is used.

### Example 3: Determination of Property Profiles of the Adhesive-Sealants Produced

The adhesive-sealants obtained in examples 1 and 2 and comparative examples C₁ and C₂ were allowed to crosslink and investigated with respect to skin formation and mechanical properties thereof. The results can be found in Table 1.

### Skin Formation Time (SFT)

To determine the skin formation time, the crosslinkable compositions obtained in the examples are applied in a 2 mm thick layer on PE film and stored at standard conditions (23° C. and 50% relative humidity). During curing, the skin formation is tested once per minute. For this purpose, a dry laboratory spatula is carefully placed on the surface of the sample and pulled upwards. If the sample sticks to the finger, no skin has yet formed. If no sample remains stuck to the finger, a skin has formed and the time is noted.

### Mechanical Properties

The compositions are each spread on milled-out Teflon® panels to a depth of 2 mm and cured for 2 weeks at 23° C. and 50% relative humidity.

The Shore A hardness is determined according to DIN 53505. The tensile strength is determined according to DIN 53504-S1. Elongation at break is determined according to DIN 53504-S1. The 100% modulus is determined according to DIN 53504-S1.

TABLE 1

| Example | 1 | C1* | 2 | C2* |
|---|---|---|---|---|
| SFT [min] | 7 | 7 | 25 | 29 |
| Hardness [Shore A] | 59 | 68 | 21 | 40 |
| 100% modulus [N/mm] | 2.8 | 3.9 | 0.6 | 1.2 |
| Tensile strength [N/mm] | 3.4 | 4.3 | 1.1 | 2.4 |
| Elongation at break [%] | 133 | 126 | 228 | 190 |

*non-inventive

1-10. (canceled)

11. An organyloxysilyl-terminated polymer (P), comprising:
wherein the organyloxysilyl-terminated polymer (P) has end groups of the formula (I)
—(CR¹₂)_{b}—SiRₐ(OR²)₃₋ₐ (I);
wherein R may be identical or different and is a monovalent, unsubstituted or substituted, SiC-bonded hydrocarbon radical;
wherein R¹ may be identical or different and is a hydrogen atom or a monovalent, unsubstituted or substituted hydrocarbon radical;
wherein R² may be identical or different and is a hydrogen atom or a monovalent, unsubstituted or substituted hydrocarbon radical;
wherein a may be identical or different and is 0, 1 or 2; and
wherein b may be identical or different and is an integer from 1 to 10;
wherein the organyloxysilyl-terminated polymer (P) further comprises 1,3-dioxolane copolymer units (DP) of the general formula (II) in the backbone thereof
—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴—O—CH₂)]_{y2}—O— (II),
wherein R³ may be identical or different and is hydrogen or a monovalent, unsubstituted or substituted C₁- to C₁₈-alkyl radical;
wherein R⁴ may be identical or different and is hydrogen or a monovalent, unsubstituted or substituted C₁- to C₁₈-alkyl radical;
wherein x1+x2 has values of 10 to 2000;
wherein y1+y2 has values of 3+(x1+x2+y1+y2)/100 to 90+(x1+x2+y1+y2)/100; and
wherein the [O—CH₂—O—CHR³—CHR⁴-]_{y1} and [O—CHR³—CHR⁴O—CH₂-]_{y2} units, in each case at least one radical R³ or R⁴ is a C₁- to C₁₈-alkyl radical.

12. The organyloxysilyl-terminated polymers (P) of claim 11, wherein R is selected from alkyl radicals having 1 or 2 carbon atoms.

13. The organyloxysilyl-terminated polymers (P) of claim 11, wherein R¹ is a hydrogen atom.

14. The organyloxysilyl-terminated polymers (P) of claim 11, wherein R² is selected from methyl radical and ethyl radical.

15. The organyloxysilyl-terminated polymers (P) of claim 11, wherein R³ and R⁴ are selected from hydrogen atoms and C₁- to C₆-alkyl radicals.

16. The organyloxysilyl-terminated polymers (P) of claim 11, wherein in each case only one radical R³ or R⁴ in the [O—CH₂—O—CHR³—CHR⁴-]y and [O—CHR³—CHR⁴O—CH₂-]_{y2} units is a C₁- to C₁₈-alkyl radical, whereas the other radical is in each case a hydrogen atom.

17. The organyloxysilyl-terminated polymers (P) of claim 11, wherein the 1,3-dioxolane copolymer units (DP) of the formula (II) have a number-average molecular weight Mₙ between 750 and 300 000 Dalton.

18. The organyloxysilyl-terminated polymers (P) of claim 11, further comprising at least one further constituent selected from (A) nitrogen-containing organosilicon compounds, (B) silicone resins, (C) catalysts, (D) adhesion promoters, (E) water scavengers, (F) fillers, (G) additives and (H) aggregates.

19. The organyloxysilyl-terminated polymers (P) of claim 11, wherein the organyloxysilyl-terminated polymers (P) are used in an adhesive or a sealant.

20. A process (P3) for producing organyloxysilyl-terminated polymers (P), comprising:
providing organyloxysilyl-terminated polymers (P), wherein the organyloxysilyl-terminated polymer (P) has end groups of the formula (I)
—(CR¹₂)_{b}—SiRₐ(OR²)₃₋ₐ (I);
wherein R may be identical or different and is a monovalent, unsubstituted or substituted, SiC-bonded hydrocarbon radical,
wherein R¹ may be identical or different and is a hydrogen atom or a monovalent, unsubstituted or substituted hydrocarbon radical,
wherein R² may be identical or different and is a hydrogen atom or a monovalent, unsubstituted or substituted hydrocarbon radical,
wherein a may be identical or different and is 0, 1 or 2, and
wherein b may be identical or different and is an integer from 1 to 10;
wherein the organyloxysilyl-terminated polymer (P) further comprises 1,3-dioxolane copolymer units (DP) of the general formula (II) in the backbone thereof
—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴—O—CH₂)]_{y2}—O— (II),
wherein R³ may be identical or different and is hydrogen or a monovalent, unsubstituted or substituted C₁- to C₁₈-alkyl radical,
wherein R⁴ may be identical or different and is hydrogen or a monovalent, unsubstituted or substituted C₁- to C₁₈-alkyl radical,
wherein x1+x2 has values of 10 to 2000,
wherein y1+y2 has values of 3+(x1+x2+y1+y2)/100 to 90+(x1+x2+y1+y2)/100, and
wherein the [O—CH₂—O—CHR³—CHR⁴-]_{y1} and [O—CHR³—CHR⁴⁰—CH₂-]_{y2} units, in each case at least one radical R³ or R⁴ is a C₁- to C₁₈-alkyl radical; and
wherein hydroxyl-terminated 1,3-dioxolane copolymers (DP-OH) of the general formula (III)
H—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴—O—CH₂)]_{y2}—OH (III),
are reacted with at least one isocyanate-functional silane of the formula (V)
OCN—(CR¹₂)_{b}—SiRₐ(OR²)₃₋ₐ (V),
wherein R may be identical or different and is a monovalent, unsubstituted or substituted, SiC-bonded hydrocarbon radical,
wherein R¹ may be identical or different and is a hydrogen atom or a monovalent, unsubstituted or substituted hydrocarbon radical,
wherein R² may be identical or different and is a hydrogen atom or a monovalent, unsubstituted or substituted hydrocarbon radical,
wherein R³ may be identical or different and is hydrogen or a monovalent, unsubstituted or substituted C₁- to C₁₈-alkyl radical,
wherein R⁴ may be identical or different and is hydrogen or a monovalent, unsubstituted or substituted C₁- to C₁₈-alkyl radical,
wherein x1+x2 has values of 10 to 2000, and
wherein y1+y2 has values of 3+(x1+x2+y1+y2)/100 to 90+(x1+x2+y1+y2)/100.

21. The process of claim 20, wherein the organyloxysilyl-terminated polymers (P) further comprises at least one further constituent selected from (A) nitrogen-containing organosilicon compounds, (B) silicone resins, (C) catalysts, (D) adhesion promoters, (E) water scavengers, (F) fillers, (G) additives and (H) aggregates.

22. The process of claim 20, wherein the organyloxysilyl-terminated polymers (P) produced is incorporated within an adhesive or a sealant composition.

23. An adhesive or sealant composition, comprising:
wherein the adhesive or sealant composition comprises organyloxysilyl-terminated polymers (P), wherein the organyloxysilyl-terminated polymer (P) has end groups of the formula (I)
—(CR¹₂)_{b}—SiRₐ(OR²)₃₋ₐ (I);
wherein R may be identical or different and is a monovalent, unsubstituted or substituted, SiC-bonded hydrocarbon radical;
wherein R¹ may be identical or different and is a hydrogen atom or a monovalent, unsubstituted or substituted hydrocarbon radical;
wherein R² may be identical or different and is a hydrogen atom or a monovalent, unsubstituted or substituted hydrocarbon radical;
wherein a may be identical or different and is 0, 1 or 2; and
wherein b may be identical or different and is an integer from 1 to 10;
wherein the organyloxysilyl-terminated polymer (P) further comprises 1,3-dioxolane copolymer units (DP) of the general formula (II) in the backbone thereof
—[(O—CH₂—O—CH₂—CH₂—)ₓ₁(O—CH₂—CH₂—O—CH₂—)ₓ₂(O—CH₂—O—CHR³—CHR⁴—)_{y1}(O—CHR³—CHR⁴—O—CH₂)]_{y2}—O— (II),
wherein R³ may be identical or different and is hydrogen or a monovalent, unsubstituted or substituted C₁- to C₁₈-alkyl radical;
wherein R⁴ may be identical or different and is hydrogen or a monovalent, unsubstituted or substituted C₁- to C₁₈-alkyl radical;
wherein x1+x2 has values of 10 to 2000;
wherein y1+y2 has values of 3·(x1+x2+y1+y2)/100 to 90·(x1+x2+y1+y2)/100; and
wherein the [O—CH₂—O—CHR³—CHR⁴-]_{y1} and [O—CHR³—CHR⁴O—CH₂-]_{y2} units, in each case at least one radical R³ or R⁴ is a C₁- to Cis-alkyl radical.
